(19) United States
(12) Patent Application Publication
(10) Pub. No.: US 2024/0337251 A1
(43) Pub. Date: Oct. 10, 2024

(54) VERTICAL AXIS WIND TURBINE

(71) Applicant: Verta AS, Røyneberg (NO)

(72) Inventors: Sergey PILOSOV, Stavanger (NO); Alexander IBRAGIMOV, Røyneberg (NO)

(73) Assignee: Verta AS, Røyneberg (NO)

(21) Appl. No.: 18/573,137

(22) PCT Filed: Jun. 22, 2022
(86) PCT No.: PCT/NO2022/050146

§ 371 Date: Dec. 21, 2023

(30) Foreign Application Priority Data
Jul. 2, 2021 (NO) 20210857

(51) Int. Cl. F03D 7/06; F03D 3/00; F03D 3/06; F03D 9/25

(52) U.S. Cl. CPC F03D 7/06; F03D 3/005; F03D 3/062; F03D 9/25

(57) ABSTRACT

A vertical axis wind turbine (1) comprising a rotor (9) with rotor blades (11). The rotor rotates about a rotational axis, crosswise to an initial direction of the wind. The wind turbine has an annular, main guide face (5), having a convex shape, guiding the direction of air flow from the initial direction into an operating direction. There are one or more drainage channels (23) with a drainage channel opening (21) at one end of the drainage channel. The drainage channel opening is arranged on the convex main guide face. The turbine has a gap (19) with a gap inlet (19a) and a gap outlet (19b). The gap (19) is configured to receive air flow from the wind into the gap inlet and out of the gap outlet. The one or more drainage channels (23) have a drainage channel exit (25) arranged in the gap (19).

### TECHNICAL FIELD

The present invention relates to a wind turbine configured to convert kinetic energy of the wind into mechanical, rotary energy. In particular, it relates to a wind turbine of the type where the axis of rotation is transversal to the direction of the wind, typically a vertical-axis wind turbine.

### BACKGROUND ART

While the conventional horizontal axis turbines have rotational axes that are arranged in the same plane as the wind direction, typically parallel with the earth or water surface, another type has its axis of rotation transversal to the wind direction. Typically, this latter type of turbines has the axis of rotation in a vertical configuration, thus crosswise to the horizontally moving wind. An advantage of such turbines is that its effectiveness or output is not dependent on the wind direction, they are omnidirectional. As a consequence, these types of wind turbines do not need a yaw system.

The turbine rotor typically has a transversally oriented shaft, extending along said rotational axis, and rotating blades that rotate with the shaft. To rotate the turbine rotor, the direction of the wind shall be changed. Typically, the axis of rotation will be vertical, such that the direction of the wind is changed from a horizontal direction into a vertical direction.

To obtain such directional change of the wind, it is known to arrange ring-shaped deflectors with a curved guiding surface along which the wind, i.e. the moving air, will flow.

International patent publication WO2018208169 discloses a wind turbine of the above discussed type, having a plurality of annular deflectors to alter the direction of the incoming wind. The deflectors have a wing cross-section comprising a curved surface and are arranged in a form of multi slotted flaps. The annular guiding surfaces are divided by vertical mounting plates into several segments. The partitioning of the turbine inlet results in reduction of the rotor swept area, which in turns results in a low power output of the wind turbine. Furthermore, such construction of the turbine has a high flow resistance upstream the rotor and a high overall drag.

U.S. Pat. No. 2,008,023,964 discloses an omnidirectional wind turbine of the above discussed type, where the horizontally moving air flow is bent upwards towards a vertical direction. The turbine design has a plurality of vertically separated annular curved deflectors arranged in a vertical stack by means of vertical support members. Such design of the inlet has a high interference drag and as a result high turbulence upstream the turbine rotor. The overall drag coefficient of the described turbine is also high. Furthermore, there is a relatively large vertical distance between some of the deflectors and the rotational plane where the airflow impacts the rotor blades. An excessive vertical distance between the deflectors and the rotational plane results in loss of velocity of the flow and less efficiency of the turbine.

U.S. Pat. No. 20,140,212,285 also discloses an omnidirectional wind turbine for electric power generation. In this solution, a turbine rotor is enclosed in an annular diffuser with the cross-sectional shape of a wing. One of the drawbacks of the known technical solution is related to flow (boundary layer) separation from the guide surface of the diffuser. It will be readily understood by those skilled in the art that that the flow, under the action of viscous friction forces and an adverse pressure gradient, will separate from the surface before it changes its direction from horizontal to vertical. When the flow detaches from the guide surface, it becomes turbulent and it will move towards turbine rotor at a certain angle, also known as yaw misalignment angle. The yaw misalignment has a negative impact on aerodynamic torque and rotor angular speed. This fact, as well as the presence of the turbulent vortexes in the flow upstream the rotor, significantly reduce the total efficiency of the turbine and consequently the total power production. To increase efficiency, one of the described embodiments of the known technical solution features an annular diffuser consisting of two annular deflectors (aerodynamic elements). The deflectors are arranged vertically in a form of slotted flaps. When wind impacts this type of diffuser, a low pressure will be created at approximately ⅔ of the diffuser circumference, at the rear area of the turbine. This low pressure area on the outer part of the diffuser results in air overflow through the slot, i.e. a part of the flow leaves the turbine without affecting the rotor blades.

Another disadvantage of prior designs where the wind turbine is used to generate electric power, is related to passive ambient air cooling. It is well known that the resistivity of the alternator windings is directly proportional to their temperature, and the power output is inversely proportional to the resistivity. Obviously, all other things being equal, a turbine generator with a better cooling system will generate more electricity over a period of time or will have a wider wind speed operating range.

A prior art wind turbine where this problem is addressed is described in international application WO2018208169. Its turbine housing exhibits vents that are evenly distributed along the circumferences in the upper and the lower part of the housing. Inlet vents are located in the lower part of the housing while outlet vents are located in the upper part upstream the rotor.

Other disadvantages of prior designs may involve the presence of mechanical flow obstacles. Such obstacles can particularly be support structures arranged upstream the turbine rotor. As described above, low-pressure areas, like that of inner surface of the annular diffuser, are susceptible to flow separation. Turbulence induced by support structures will lead to flow separation and as a result to lower turbine performance.

Generally, and as touched upon above, problems associated with known wind turbine designs of the mentioned type, include high flow resistance and strong vortex formation both upstream and downstream the turbine. Aerodynamic resistance of the turbine structure reduces inflow stream into the turbine, causing it to stream around the turbine and not through it. That is equivalent to reduction of the rotor swept area which implies significant negative impact on the turbine efficiency and power output.

Strong vortex formation upstream the turbine due to interference drag decreases aerodynamic performance of the turbine and the total power output.

Furthermore, high drag coefficient of the entire structure causes increased loadings on the foundation and as a result increased installation costs. In addition, extensive vortex formation downstream of the turbine increases footprint of the turbine. This, in turn, affects the degree of compactness of the turbine layout at a geographical area.

### SUMMARY OF INVENTION

According to a first aspect of the present invention, there is provided a vertical axis wind turbine comprising a rotor with rotor blades. The rotor is configured to rotate about a rotational axis that is crosswise to an initial direction of the wind. The wind turbine comprises an annular, main guide face, which exhibits a convex shape, and which is configured to guide the direction of air flow from the initial direction into an operating direction. Furthermore, the wind turbine comprises one or more drainage channels having a drainage channel opening at one end of the drainage channel, wherein the drainage channel opening is arranged on the convex main guide face. It also comprises a gap having a gap inlet and a gap outlet, wherein the gap is configured to receive air flow from the wind into the gap inlet and out of the gap outlet. According to the invention, the one or more drainage channels have a drainage channel exit arranged in the gap.

With the term vertical axis wind turbine is meant wind turbines wherein the axis of the rotor rotation is arranged with a vertical or substantially vertical orientation. Typically, for such wind turbines the axis of rotation will be substantially transversal to the direction of the wind.

By passing a flow of air through the gap formed by the outer and the inner parts of the deflector and the vertical streamlined elements, a low pressure area will be created in the gap due to the Venturi effect. This low-pressure area, created on the windward part of the turbine, is used for draining some air from the main guide surface through the drainage channel openings. The boundary layer suction will prevent, or at least delay or reduce separation of the air flow from the main guide surface. This results in enhanced aerodynamic characteristics of the flow upstream the turbine rotor.

In many embodiments, the wind turbine can further comprise an electric generator configured to convert the energy from the air flow into electric power.

The wind turbine according to the present invention can comprise few components and exhibit low drag. Furthermore, it can be provided with a small vertical extension.

In preferred embodiments, the main guide surface shall correspond to a shape which ensures a constant flow pressure gradient, preferably a shape corresponding to a portion of a lemniscate curve. An advantage of such curves is that they provide the most favorable flow conditions with regards to boundary layer separation and backflow.

In some embodiments, the wind turbine can comprise an annular deflector comprising said main guide surface. Also, it can further comprise an auxiliary flow guide, wherein the gap is provided between the annular deflector and the auxiliary flow guide.

The cross section of the gap at the gap inlet can in some embodiments be larger than the cross section of the gap at the position of the drainage channel exit.

The wind turbine can comprise gap elements that bridge the gap, wherein the drainage channel exits are arranged between gap elements. The air flowing through the gap will then obtain an increase of speed when passing through the gap elements. This will further increase the flow velocity and decrease the pressure. Advantageously, the gap elements can have a streamlined shape to avoid energy losses due to excessive drag of the air flowing through the gap.

In some embodiments, the wind turbine can further comprise an electric generator configured to generate electric power, and a generator cooling system. In such embodiments, the generator cooling system can comprise a cooling air flow path configured to flow past and to cool said electric generator, a blade flow channel which is a part of the rotor blade, wherein one or more rotor blades comprises a blade flow channel. The generator cooling system can further comprise an air inlet and an air outlet on respective sides of the cooling air flow path, wherein the air outlet constitutes an end of the blade flow channel. In some embodiments, the air outlets on the rotor blades can be arranged on the end portion of the rotor blades. Furthermore, in some embodiments the air outlets can be directed in a rotationally rearwards direction. For instance, if the rotor is configured to rotate in the clockwise direction, the air outlets would be directed in the counterclockwise direction.

In some embodiments, the vertical extension of the auxiliary flow guide can extend vertically within the vertical extension of the annular deflector, or extend vertically beyond the vertical extension of the annular deflector with a vertical distance less than ⅕ of the vertical extension of the annular deflector.

Thus, in such embodiments, the annular deflector will govern the vertical extension of the wind turbine. Advantageously, the wind turbine comprises only one annular deflector. In such embodiments, the one annular deflector is the component that governs the axial extension of the wind turbine.

In some embodiments, the air inlet can be arranged on a generator housing of the electric generator.

Advantageously, the air inlet on the generator housing can be arranged downstream of the rotor blades.

According to a second aspect of the invention, there is provided a rotor comprising rotor blades and an electric rotating machine being an electric generator configured to generate electric power when the rotor is rotated or an electric motor configured to rotate the rotor when powered with electric power. According to the second aspect of the invention, the rotor further comprises a rotating machine cooling system that comprises a cooling air flow path configured to flow past and to cool said electric rotating machine, a blade flow channel which is a part of the rotor blade, wherein one or more rotor blades comprises a blade flow channel, and further an air inlet and an air outlet on respective sides of the cooling air flow path, wherein the air outlet constitutes an end of the blade flow channel.

In some embodiments, the air inlet can be arranged on a machine housing of the electric machine. Advantageously, the air inlet on the machine housing can be arranged downstream of the rotor blades.

According to a third aspect of the present invention, there is provided a wind turbine comprising a rotor with rotor blades and an electric generator connected to the rotor. The rotor is configured to rotate about a rotational axis that is crosswise to an initial direction of the wind, wherein an outer surface of the wind turbine is provided with vortex-generating elements configured to provide a turbulent air flow along said outer surface, as the outer surface exhibits a relative roughness in the range from 0,01 to 0,04.

### DETAILED DESCRIPTION OF THE INVENTION

While the present invention has been discussed in general terms above, a more detailed and non-limiting example of embodiment will be discussed in the following with reference to the drawings, in which

FIG. 1 is a perspective view of a wind turbine according to the present invention;

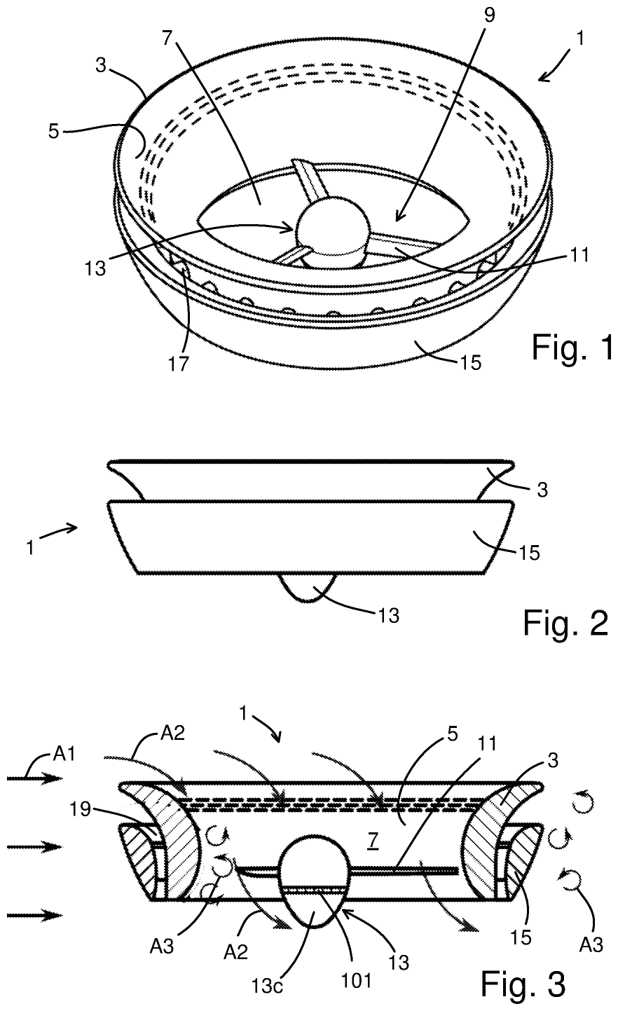

FIG. 2 is a side view of the wind turbine shown in FIG. 1;

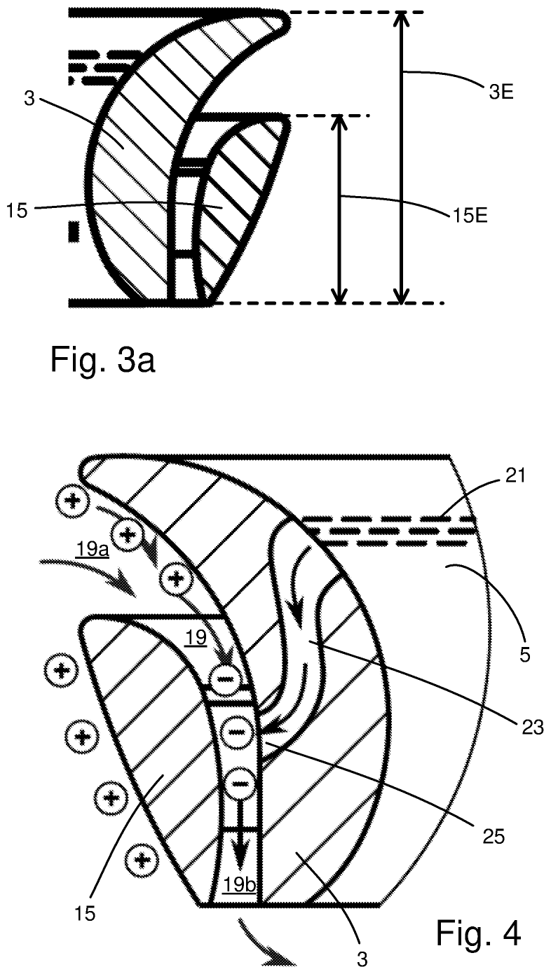

FIG. 3 is a cross-section side view of the wind turbine shown in FIG. 2;

FIG. 3a is an enlarged view of a portion of FIG. 3;

FIG. 4 is an enlarged cross-section side view of a portion of the wind turbine;

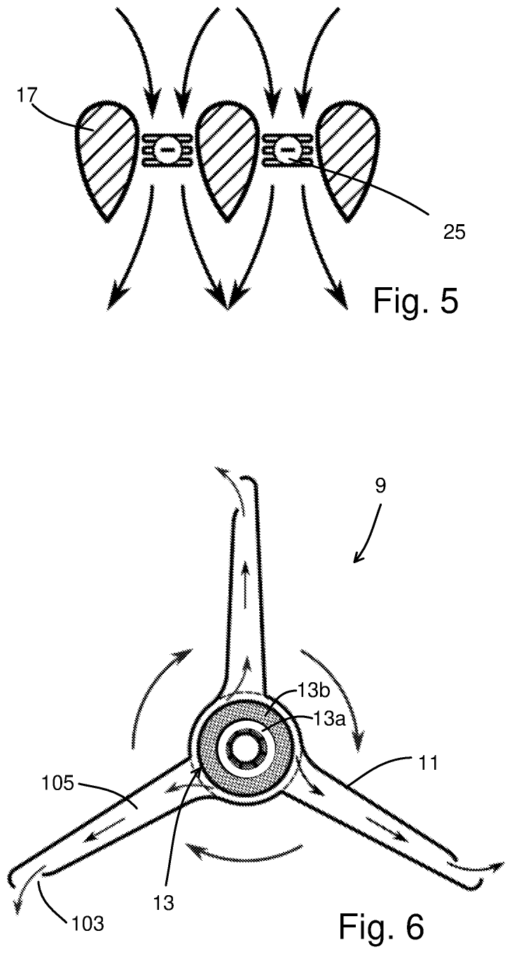

FIG. 5 is another cross section view through a portion of the wind-turbine;

FIG. 6 is a top view of the rotor of the wind turbine shown in FIG. 1;

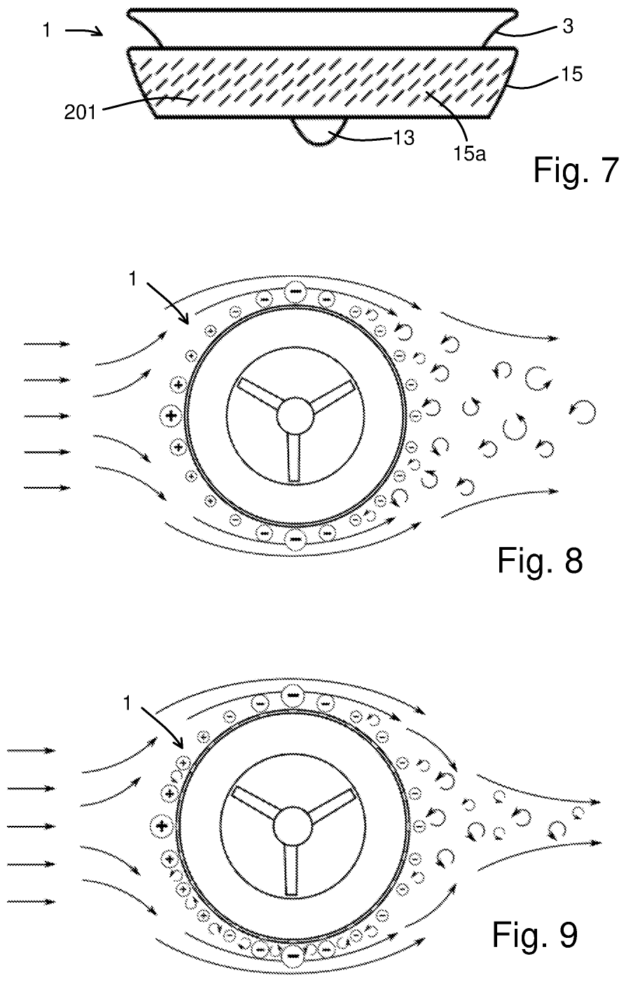

FIG. 7 is a side view of an alternative embodiment of a wind turbine;

FIG. 8 and FIG. 9 are side views illustrating air flow past a wind turbine with and without the solution shown in FIG. 7.

FIG. 1 is a perspective view showing an embodiment of a wind turbine 1 according to the present invention. The wind turbine comprises an annular deflector 3 with a main guide face 5.

The wind turbine 1 has a rotor 9 arranged within the annular deflector 3. The rotor 9, which comprises rotor blades 11, is made to rotate with its rotor blades 11 rotating along a rotational plane 7. The rotor 9 is mechanically connected to an electric generator 13 configured to produce electric power when rotated. It is noted that although the wind turbine 1 of the present example of embodiment has an electric generator, other embodiments of the invention may relate to a wind turbine without an electric generator. Such embodiments may, for instance, relate to wind turbines wherein their mechanical power is used directly, for instance to run a water pump or to run other mechanical devices.

The rotor 9 is suspended for instance with a (not shown) suspension element fixed to the annular deflector 3.

Advantageously, suspension means for suspension of the rotor with respect to the annular deflector 3, for instance said suspension element, is arranged downstream of the rotor 9. In this manner, the airflow upstream of the rotor is not affected by the suspension means.

As will be appreciated, the annular deflector 3 is, by means of its main guide face 5, configured to alter the direction of the incoming wind onto the rotational plane 7, thus transferring energy from the airflow to the rotor 9.

Arranged radially outside the annular deflector 3, the wind turbine 1 comprises an auxiliary flow guide 15. The auxiliary flow guide 15 is annular and extends about the annular deflector 3. As will be discussed further below, there is a flow gap 19 (cf. FIG. 3) present between the annular deflector 3 and the auxiliary flow guide 15. The auxiliary flow guide 15 is fixed to the annular deflector 3 by means of gap elements 17 that bridge the flow gap 19. In the shown example (cf. FIG. 5), the gap elements are in the form of streamlined elements 17. FIG. 2 is a side view and FIG. 3 is a cross section side view of the wind turbine 1 according to the invention.

As indicated with the arrows A1 shown in the image of FIG. 3, in the present example it is assumed that free flow (i.e. wind) moves from the left towards the right. Also indicated, with the arrows A2, is a flow of air that is guided into at least a partly vertical direction, through the rotational plane 7. The circular arrows A3 indicate portions where there is a turbulent air flow.

When the air (wind) flows onto the wind turbine 1 from the side, i.e. from the left in this example, it will follow the main guide face 5 of the annular deflector 3. The main guide face 5 has a curved configuration that changes the direction of the flow from being crosswise with respect to the axis of rotation of the rotor 9, to a direction that is at least partially parallel to the said axis (i.e. it has a directional component parallel to the said axis). This change of direction is illustrated with the curved arrows A2 in FIG. 3. As a consequence, the air flows through the rotational plane 7 and rotates the rotor 9 due to interaction with the rotor blades 11.

As the skilled person will appreciate, the wind turbine will be more effective if the direction of the air flow is changed as much as possible towards a direction parallel with the axis of rotation of the rotor 9. I.e. its direction should preferably be aligned with the direction of the axis of rotation of the rotor 9. To obtain such a directional change as best as possible, the air flow needs to follow the main guide face 5 without separating from it. It is known in the art that if the angle or curvature of such a guide face is too large or abrupt, respectively, the air flow will separate from the guide surface.

The present invention provides a means to prevent or at least reduce such separation.

FIG. 3a depicts an enlarged view of the image shown in FIG. 3. As indicated in FIG. 3a, the annular deflector 3 and the auxiliary flow guide 15 have different vertical extensions. The vertical extension 3E of the annular deflector 3 is larger than the vertical extension 15E of the auxiliary flow guide 15. Moreover, in this embodiment, the vertical extension 15E of the auxiliary flow guide 15 is arranged fully within the vertical extension 3E of the annular deflector 3.

Reference is now made to FIG. 4, which shows an enlarged cross section view through the annular deflector 3 and the auxiliary flow guide 15. The flow gap 19 between the annular deflector 3 and the auxiliary flow guide 15 comprises a gap inlet 19a and a gap outlet 19b. The flow gap 19 is shaped as a conical channel, as its inlet 19a area is larger than its outlet 19b area. As indicated with the arrows in FIG. 4, when the air flow meets the wind turbine 1 from the side, some of the flow will be guided into the gap inlet 19a, through the flow gap 19 and out from the gap outlet 19b.

In addition to the arrows, which illustrate the direction of air flow, gauge pressures are indicated with plus signs and minus signs. At the gap inlet 19a, the area of the entrance of the flow gap 19 is larger than the area inside the flow gap 19 itself. I.e. the flowing air will flow through a channel that is narrowed or constricted along its flow path. The gauge pressure at the gap inlet 19a is thus relatively high, while the gauge pressure inside the flow gap 19, is relatively low. This is due to the increased flow velocity inside the flow gap 19.

Still referring to FIG. 4, arranged on the main guide face 5, there is one or more drainage channel openings, here in the form of slots 21. The drainage channel openings, i.e. the slots 21, are fluidly connected with drainage channels 23 that extend between said slots 21 and the flow gap 19. In particular, the drainage channel 23 connects to the flow gap 19 at a portion of the flow gap 19 where there is a low pressure, namely at a drainage channel exit 25 at the opposite end of the drainage channel 23.

FIG. 5 depicts, with an enlarged cross-section view, three of the streamlined elements 17 that connect the annular deflector 3 and the auxiliary flow guide 15. I.e. the streamlined elements 17 bridge the flow gap 19. As will be understood, the velocity of the air flow through the flow gap 19 will be even further increased at the area between the streamlined elements 17.

Consequently, the pressure at these positions will be even further reduced. Also indicated in FIG. 5, at the minus-signs, are drainage channel exits 25. Some air will thus be drawn from the slots 21, through the drainage channel 23 and into the flow gap 19 due to the Venturi effect.

Consequently, some of the air that flows along the main guide face 5 will be drained away, into the slots 21. This will delay separation of the air flow along the main guide face 5.

As indicated with the arrows, the air that flows through the flow gap 19 will, together with the air drained through the slots 21, exit the flow gap 19 at the gap outlet 19b.

It is expected that by draining a small amount of air, e.g. about 2 to 4% of the air flowing through the rotational plane 7, the energy loss will be significantly reduced, such as about 30%. This is, as indicated above, due to less separation of the flow from the main guide face 5.

Reference is now made to FIG. 6, which shows a cross-section view through the rotor 9, comprising three rotor blades 11, seen in a direction parallel to the axis of rotation of the rotor 9. The electric generator 13 is centrally arranged, such that the axis of rotation extends through it. The rotor blades 11 extend radially out from the electric generator 13 in this embodiment.

The electric generator 13 comprises a generator stator 13a that is fixed with respect to the annular deflector 3, and a generator rotor 13b that rotates with the rotor blades 11.

The wind turbine 1 comprises a rotating machine cooling system, which in the present embodiment is a generator cooling system 100. The generator cooling system 100 comprises an air inlet 101, which appears in FIG. 3. In this embodiment, the air inlet 101 is arranged on a generator housing 13c.

The generator cooling system 100 further comprises air outlets 103, which are arranged on the rotor blades 11. In this embodiment, the air outlets 103 are arranged on the ends of the rotor blades 11. Furthermore, the air outlets 103 are directed in a rotationally rearwards direction, as indicated in FIG. 6.

The rotor blades 11 comprises a blade flow channel 105 that constitutes a part of a cooling air flow path between the air inlet 101 and the air outlet 103. The said cooling air flow path extends past the electric generator 13, such that the electric generator 13 is cooled by the flowing air. The centrifugal force occurring within the flow channels 105 during rotation provides the flow of air through the cooling air flow path.

While the rotor 9 and the electric generator 13 shown herein is part of a wind turbine, in other embodiments such an air-cooled generator could instead be an electric motor being part of for instance a flying drone or a submersible vehicle, provided with propelling blades.

Reference is now made to FIG. 7, which depicts an alternative embodiment of a wind turbine 1 of the type that has its axis of rotation crosswise to the direction of the wind. In this embodiment, the wind turbine 1 has an annular deflector 3 and an auxiliary flow guide 15, corresponding to the wind turbine 1 discussed above. The outer surface 15a of the auxiliary flow guide 15 is provided with vortex-generating elements that provides a turbulent airflow along the surface. The vortex-generating surface can be provided in various ways. For instance, vortex-generating elements 201 may be attached onto the outer surface 15a of the auxiliary flow guide 15. Alternatively, the auxiliary flow guide 15 may be manufactured of a material or with a manufacturing method that provides said vortex-generating surface.

By providing a turbulent airflow along the surface of the wind turbine 1, in the present embodiment along the surface 15a of the auxiliary flow guide 15, the drag of the turbine 1 is reduced. As a result of the reduced drag, the wake is reduced. This is illustrated with the images of FIG. 8 and FIG. 9, respectively. FIG. 8 illustrates a wind turbine 1 without the vortex-generating elements 201, while FIG. 9 illustrates a corresponding wind turbine 1 with the said vortex-generating elements 201 arranged on the outer surface 15a of the auxiliary flow guide 15. By reducing the length and the width of the wake, one can arrange a plurality of wind turbines 1 in a more compact way.

As briefly discussed, the vortex-generating elements 201 can have various configurations. As stated above, the purpose of the vortex-generating elements 201 is to provide a turbulent flow of air along the outer surface of the wind turbine 1. The vortex-generating elements 201 can thus be recesses in the surface, such as the recesses in the surface of a golf ball. The vortex-generating elements 201 can also be in the form of protrusions that protrude out from the surface.

The surface 15a of the auxiliary flow guide 15 can advantageously exhibit a relative roughness in the range from 0,01 to 0,04.

The invention claimed is:

1. A vertical axis wind turbine comprising:
a rotor with rotor blades;
wherein the rotor is configured to rotate about a rotational axis that is crosswise to an initial direction of the wind;
an annular, main guide face, which exhibits a convex shape, and which is configured to guide the direction of air flow from the initial direction into an operating direction;
one or more drainage channels having a drainage channel opening at one end of the drainage channel, wherein the drainage channel opening is arranged on the convex main guide face;
a gap having a gap inlet and a gap outlet, wherein the gap is configured to receive air flow from the wind into the gap inlet and out of the gap outlet; and
wherein the one or more drainage channels have a drainage channel exit arranged in the gap.

2. The wind turbine according to claim 1, comprising an annular deflector comprising the main guide surface, and further comprises an auxiliary flow guide, wherein the gap is provided between the annular deflector and the auxiliary flow guide.

3. The wind turbine according to claim 2, wherein the cross section of the gap at the gap inlet is larger than the cross section of the gap at the position of the drainage channel exit.

4. The wind turbine according to claim 23, comprising gap elements that bridge the gap, wherein the drainage channel exits are arranged between gap elements.

5. The wind turbine according to claim 1, comprising an electric generator configured to generate electric power, and a generator cooling system, wherein the generator cooling system comprises
a cooling air flow path configured to flow past and to cool the electric generator;
a blade flow channel which is a part of the rotor blade, wherein one or more rotor blades comprises a blade flow channel; and
an air inlet and an air outlet on respective sides of the cooling air flow path, wherein the air outlet constitutes an end of the blade flow channel.

6. The wind turbine according to claim 2, wherein the vertical extension of the auxiliary flow guide extends vertically within the vertical extension of the annular deflector, or extends vertically beyond the vertical extension of the annular deflector with a vertical distance less than ⅕ of the vertical extension of the annular deflector.

7. The wind turbine according to claim 5, wherein the air inlet is arranged on a generator housing of the electric generator.

8. The wind turbine according to claim 1, comprising a suspension means that suspends the rotor to the non-rotating parts of the wind turbine, wherein the suspension means connects to the rotor only to the downstream side of the rotor.

9. A rotor comprising rotor blades and an electric rotating machine being an electric generator configured to generate electric power when the rotor is rotated or an electric motor configured to rotate the rotor when powered with electric power, comprising:
a rotating machine cooling system that comprises
a cooling air flow path configured to flow past and to cool the electric rotating machine;
a blade flow channel which is a part of the rotor blade, wherein one or more rotor blades comprises a blade flow channel; and
an air inlet and an air outlet on respective sides of the cooling air flow path, wherein the air outlet constitutes an end of the blade flow channel.

10. A wind turbine comprising a rotor with rotor blades and an electric generator connected to the rotor, wherein the rotor is configured to rotate about a rotational axis that is crosswise to an initial direction of the wind, wherein an outer surface of the wind turbine is provided with vortex-generating elements configured to provide a turbulent air flow along the outer surface, as the outer surface exhibits a relative roughness in the range from 0,01-0,04.
